(19) United States
(12) Patent Application Publication
(10) Pub. No.: US 2026/0051212 A1
(43) Pub. Date: Feb. 19, 2026

(54) CASH REGISTER

(71) Applicant: CHENGDING INDUSTRIAL CO., LTD., Taoyuan City (TW)

(72) Inventor: CHENG-WEN YANG, Taoyuan City (TW)

(21) Appl. No.: 18/804,876

(22) Filed: Aug. 14, 2024

(51) Int. Cl. G07D 11/40; B65H 29/14; B65H 31/26; G07D 11/14; G07D 11/16

(52) U.S. Cl. CPC G07D 11/40; B65H 29/14; B65H 31/26; G07D 11/14; G07D 11/16; B65H 2404/1532; B65H 2701/1912; G07D 2211/00

(57) ABSTRACT

A cash register includes a banknote input module including a first housing and a banknote transport mechanism, and a banknote storage module including a second housing and a banknote storage pressure plate. The first housing has a banknote inlet, a banknote outlet and a first combination frame. The banknote transport mechanism is disposed in the first housing and located at the banknote inlet and between the banknote inlet and the banknote outlet. The banknote storage pressure plate is movably disposed in the second housing and abuts against the second combination frame. The first combination frame is coupled to the second combination frame of the second housing from above or below to combine the money input module with the money storage module. A banknote enters the first housing from the banknote inlet and is transported by the banknote transport mechanism and enters the second housing through the banknote outlet.

### BACKGROUND

### 1. Technical Field

This present disclosure relates to the technical field of cash receiving equipment, specifically to a cash register.

### 2. Description of Related Art

Automatic payment devices are currently quite commonly installed in various fee-collecting places, such as parking lots or various product vending machines. The cash storage boxes of existing cash registers are usually combined with the cash collecting devices in fixed positions. However, since automatic payment devices may be installed in different locations in a place, it may be difficult to remove the cash storage box from the cash collecting device in some locations due to obstructions by the building structure or other facilities in the place.

### SUMMARY

In view of this, the purpose of the present disclosure is to provide a cash register that solves the problem in the prior art where the cash storage box is difficult to remove from the cash collecting device due to obstructions by the building structure or other facilities.

An embodiment of the cash register of this present disclosure includes a banknote input module and a banknote storage module. The banknote input module includes a first housing and a banknote transport mechanism. The first housing has a banknote inlet, a banknote outlet, and a first combination frame. The first combination frame includes a first upper wall, a first lower wall, and two first side walls. The banknote transport mechanism is disposed in the first housing and located between the banknote inlet and the banknote outlet. The banknote storage module includes a second housing and a banknote storage pressure plate. The second housing has a second combination frame. The second combination frame includes a second upper wall, a second lower wall, and two second side walls. The banknote storage pressure plate is movably disposed in the second housing and abuts against the second combination frame. By selectively coupling the first upper wall and the first lower wall respectively to the second upper wall and the second lower wall or respectively to the second lower wall and the second upper wall, the first combination frame is coupled to the second combination frame, thereby combining the banknote input module with the banknote storage module. A banknote enters the first housing from the banknote inlet and is transported by the banknote transport mechanism and enters the second housing through the banknote outlet. The banknote storage pressure plate presses the banknote to the second combination frame.

In another embodiment, the first upper wall has two first engagement recesses and a first latch recess disposed between the first engagement recesses. The first lower wall has two second engagement recesses and a second latch recess disposed between the two second engagement recesses. The second upper wall has a latch protrusion and two first engagement protrusions disposed on both sides of the latch protrusion. The second lower wall has two second engagement protrusions. The latch protrusion may be coupled to the first latch recess or the second latch recess. The first engagement protrusion may be coupled to the first engagement recess or the second engagement recess. The second engagement protrusion may be coupled to the second engagement recess or the first engagement recess.

In another embodiment, the first upper wall has a first notch. The first engagement recesses are disposed on opposite sides of the first notch. The first latch recess is disposed corresponding to the first notch. The first lower wall has a second notch. The second engagement recesses are disposed on both sides of the second notch. The second upper wall has a boss. The first engagement protrusions are disposed on both sides of the boss. The boss is coupled to the first notch or the second notch.

In another embodiment, each of the first side walls has a first stepped structure near one side of the banknote transport mechanism. Each of the second side walls has a second stepped structure near one side of a corner of the second housing. When the banknote input module is combined with the banknote storage module, the first stepped structure is coupled to the second stepped structure.

In another embodiment, each of the first side walls has a flange on a side that is away from the banknote transport mechanism. When the banknote input module is combined with the banknote storage module, the flange abuts against the second housing.

In another embodiment, the first housing further includes a banknote transport path. The banknote transport path connects the banknote inlet and the banknote outlet. The banknote transport path includes an inclined section, a horizontal section, and an arcuate section. The horizontal section is located between the inclined section and the arcuate section. The inclined section connects to the banknote inlet. The arcuate section connects to the banknote outlet. The height of the banknote inlet is greater than the height of the horizontal section and the height of the horizontal section is greater than the height of the banknote outlet.

In another embodiment, the banknote transport mechanism includes a first conveyor belt and a second conveyor belt. The first conveyor belt is disposed at the horizontal section of the banknote transport path. The second conveyor belt is disposed at the banknote outlet and the first combination frame. Banknotes are transported by the first conveyor belt and second conveyor belt.

In another embodiment, the first housing further includes a back cover. The back cover is detachably coupled to the first housing and forms the arcuate section of the banknote transport path and the banknote outlet. The back cover includes a first coupling part, an arcuate part and a second coupling part. The first coupling part and second coupling part are respectively disposed on opposite sides of the arcuate part. The first coupling part is coupled to the first housing. The second coupling part is coupled to the first combination frame. The arcuate part forms the arcuate section of the banknote transport path.

In another embodiment, the back cover further includes at least one first transport roller and at least one pressing spring. The first transport roller is disposed on the first coupling part and is opposite to the first conveyor belt of the banknote transport mechanism. The pressing spring is disposed on the arcuate part.

In another embodiment, the banknote transport mechanism further includes at least one second transport roller. The second transport roller is disposed in the arcuate section of the banknote transport path and is disposed opposite to the arcuate part of the back cover. The pressing spring abuts against the second transport roller.

By coupling the first upper wall and the first lower wall of the banknote input module respectively to the second upper wall and the second lower wall of the banknote storage module or the first upper wall and the first lower wall of the banknote input module respectively to the second lower wall and the second upper wall of the banknote storage module, the cash register of the present disclosure allows the banknote storage module to be assembled with the banknote input module from above or below according to the installation location, thereby solving the problem of experiencing difficulties in assemble and disassemble due to obstructions by the building structure or other facilities in the prior art.

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

FIG. 1 is a perspective view of an embodiment of the cash register of the present disclosure, wherein the banknote storage module is assembled to the banknote input module from the above of the banknote input module.

FIG. 2 is an exploded perspective view of the banknote input module and the banknote storage module of the cash register shown in FIG. 1.

FIG. 3 is a perspective view of the banknote storage module of the cash register shown in FIG. 1.

FIG. 4 is a perspective view of the first housing of the banknote input module of the cash register shown in FIG. 1.

FIG. 5 is another perspective view of the first housing shown in FIG. 4.

FIG. 6 is a cross-sectional view of the cash register shown in FIG. 1.

FIG. 7 is an enlarged view of part A shown in FIG. 6.

FIG. 8 is an enlarged view of part B shown in FIG. 6.

FIG. 9 is another perspective view of the cash register of the present disclosure, wherein the banknote storage module is assembled to the banknote input module from below of the banknote input module.

FIG. 10 is a cross-sectional view of the cash register shown in FIG. 9.

FIG. 11 is an enlarged view of part C shown in FIG. 10.

FIG. 12 is an enlarged view of part D shown in FIG. 10.

FIG. 13 is a perspective view of the back cover of the first housing of the banknote input module of the cash register of the present disclosure.

FIG. 14 is a cross-sectional view showing the back cover assembled to the banknote input module of the cash register of the present disclosure.

FIG. 15 is a schematic diagram showing the removal of the back cover to retrieve a jammed banknote from the banknote transport path.

### DESCRIPTION OF THE EXEMPLARY EMBODIMENTS

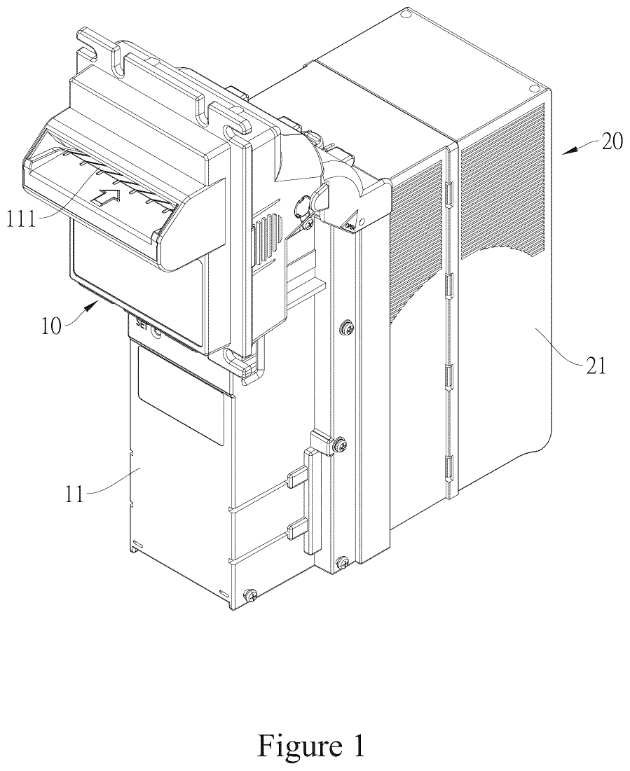

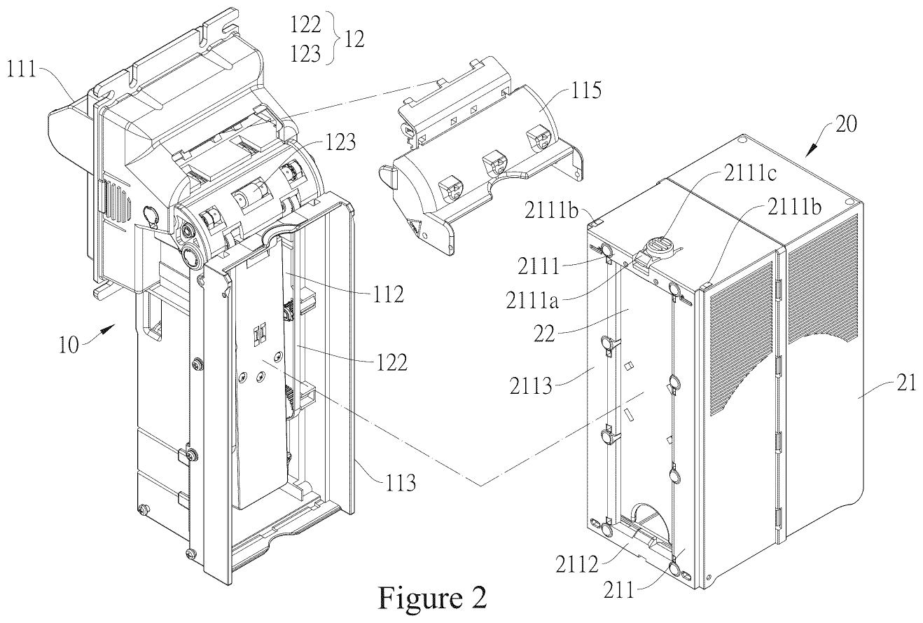

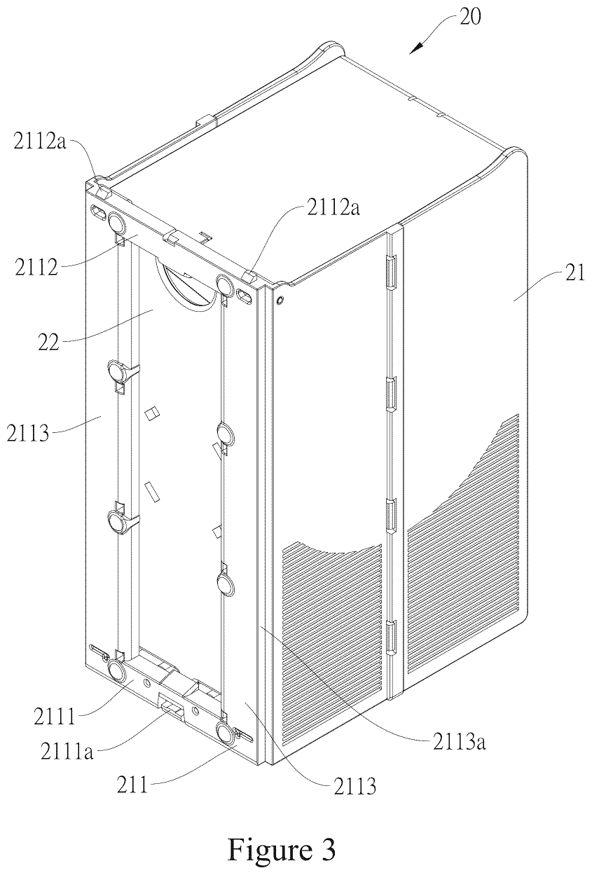

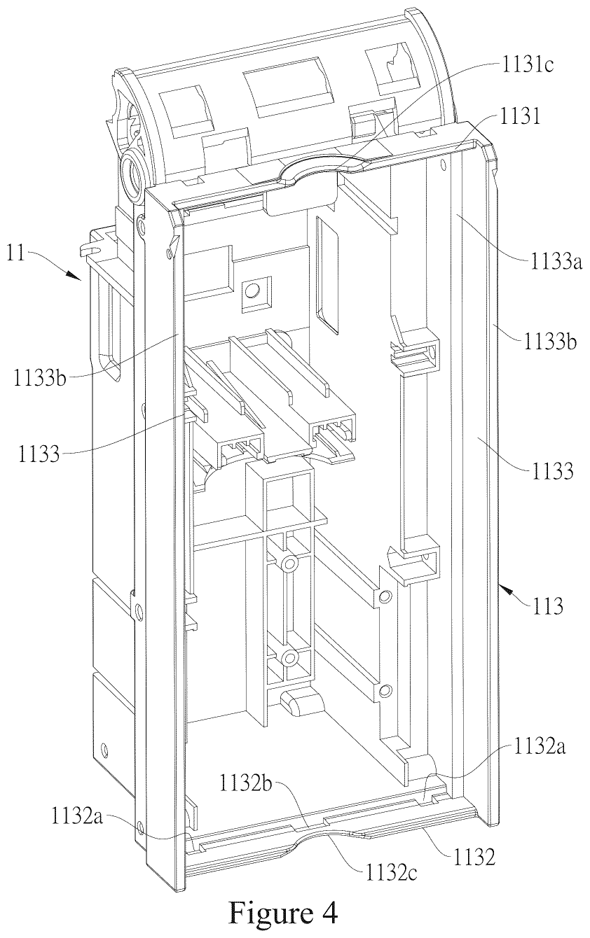

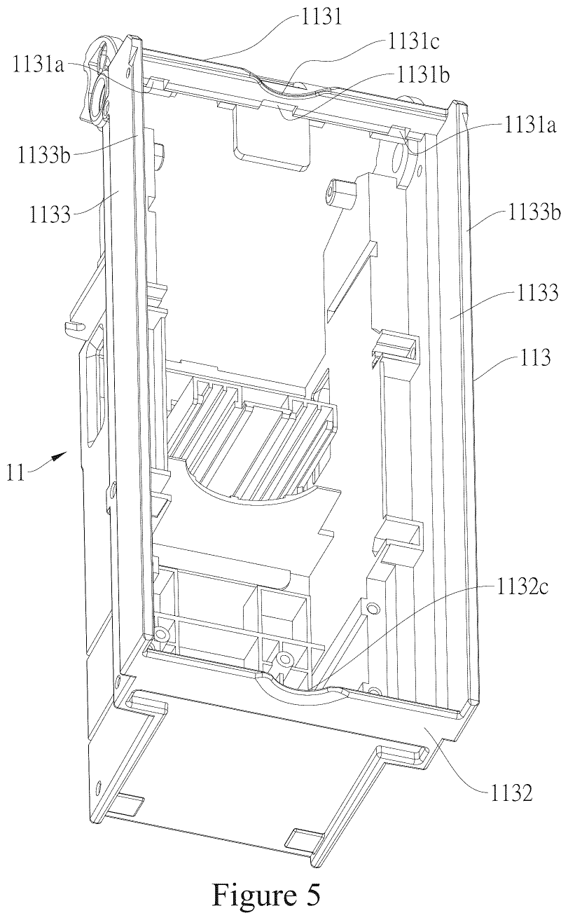

Please refer to FIGS. 1, 2, 3, 4, and 5 that illustrate an embodiment of the cash register of the present disclosure. The cash register 1 of this embodiment includes a banknote input module 10 and a banknote storage module 20. The banknote input module 10 includes a first housing 11 and a banknote transport mechanism 12. The banknote storage module 20 includes a second housing 21 and a banknote storage pressure plate 22. The banknote storage module 20 is detachably assembled to the banknote input module 10.

The first housing 11 has a banknote inlet 111, a banknote outlet 112, a first combination frame 11, and a banknote transport path 114. The first combination frame 113 includes a first upper wall 1131, a first lower wall 1132 and two first side walls 1133. The banknote transport mechanism 12 is disposed in the first housing 11 and located between the banknote inlet 111 and the banknote outlet 112.

The first upper wall 1131 has two first engagement recesses 1131a and a first latch recess 1131b disposed between the first engagement recesses 1131a, wherein the first engagement recesses 1131a and the first latch recess 1131b form the inner surface of the first upper wall 1131. The edge of the first upper wall 1131 forms a first notch 1131c. The two first engagement recesses 1131a are located on the opposite sides of the first notch 1131c.

The first lower wall 1132 has two second engagement recesses 1132a and a second latch recess 1132b disposed between the second engagement recesses 1132a, and the second engagement recesses 1132a and the second latch recess 1132b are formed on the inner surface of the first lower wall 1132. The first lower wall 1132 forms a second notch 1132c, which is aligned with the first notch 1131c.

Each of the two first side walls 1133 has a first stepped structure 1133a near one side of the banknote transport mechanism 12 and a flange 1133b on a side that is away from the banknote transport mechanism 12.

The second housing 21 has a second combination frame 211 and a banknote storage space 212. The second combination frame 211 includes a second upper wall 2111, a second lower wall 2112 and two second side walls 2113. The banknote storage pressure plate 22 is movably disposed in the second housing 21 and abuts against the second combination frame 211. The second upper wall 2111 has a latch protrusion 2111a and two first engagement protrusions 2111b disposed on both sides of the latch protrusion 2111a. The second upper wall 2111 further has a boss 2111c. The first engagement protrusions 2111b are located on both sides of the boss 2111c. The second lower wall 2112 has two second engagement protrusions 2112a. The latch protrusion 2111a is coupled to the boss 2111c. Pressing the boss 2111c can deform the latch protrusion 2111a elastically.

Each of the two second side walls 2113 has a second stepped structure 2113a on the side near the corner of the second housing 21.

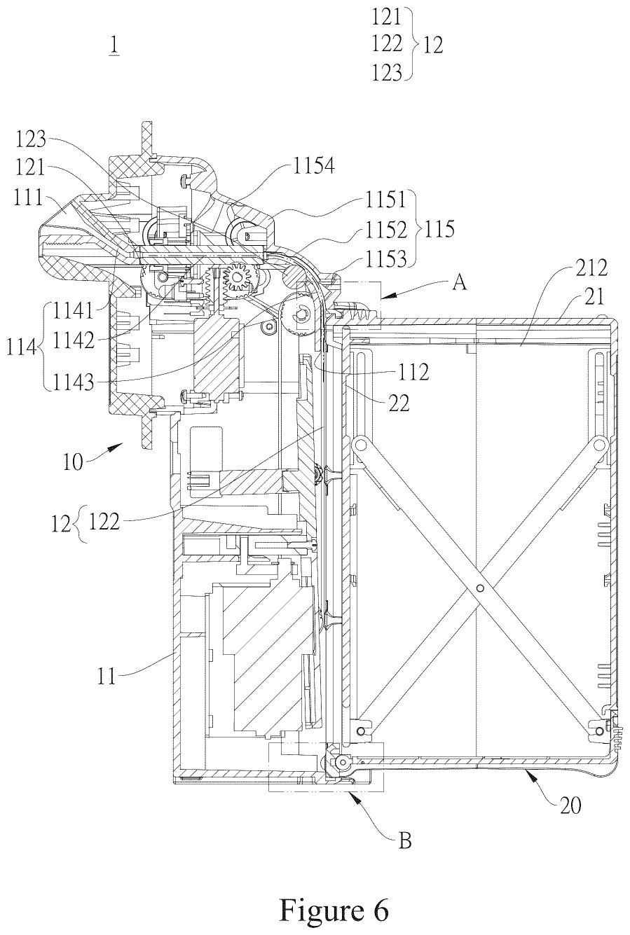

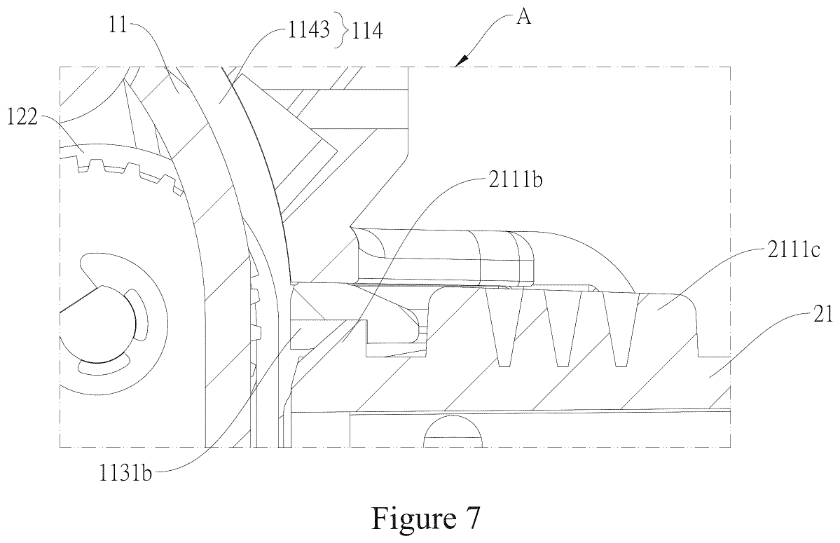

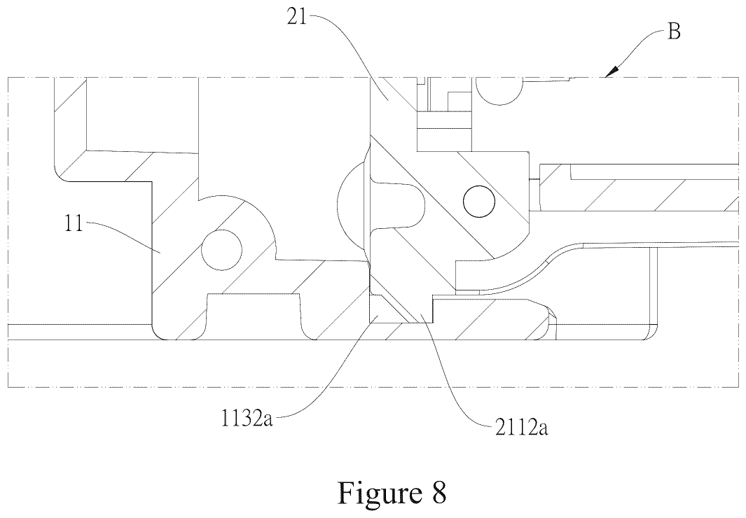

Please refer to FIGS. 6, 7, and 8. The banknote storage module 20 is assembled to the banknote input module 10 from the above of the banknote input module 10. The second housing 21 is coupled to the first housing 11. The flange 1133b of the first side wall 1133 abuts against the second side wall 2113 and the second stepped structure 2113a engages with the first stepped structure 1133a, thereby coupling the first combination frame 113 to the second combination frame 211. By aligning the boss 2111c with the first notch 1131c, the latch protrusion 2111a engages with the first latch recess 1131b and the first engagement protrusions 2111b engage with the first engagement recesses 1131a, while the second engagement protrusions 2112a engage with the second engagement recesses 1132a. This causes the first upper wall 1131 and the first lower wall 1132 to correspondingly couple with the second upper wall 2111 and the second lower wall 2112, forming a constraint in three mutually orthogonal directions in three dimensions.

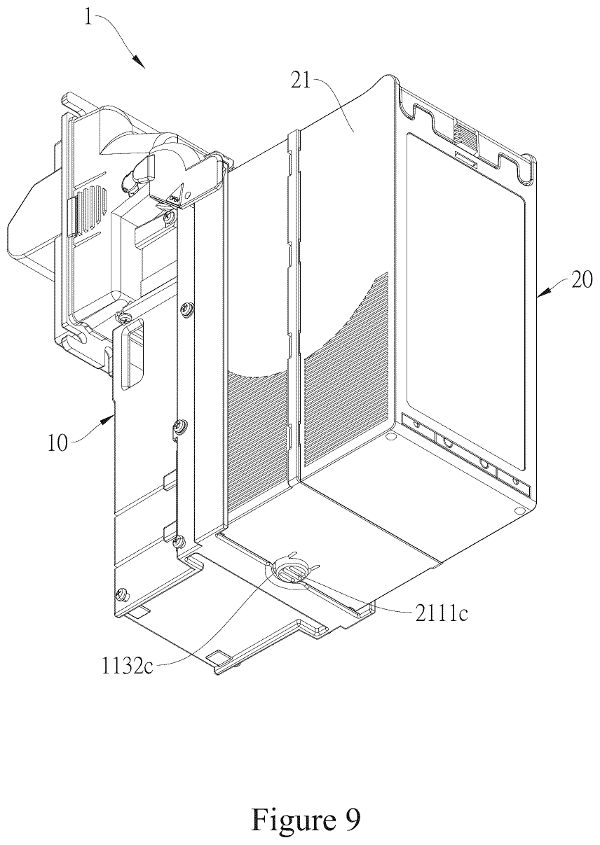

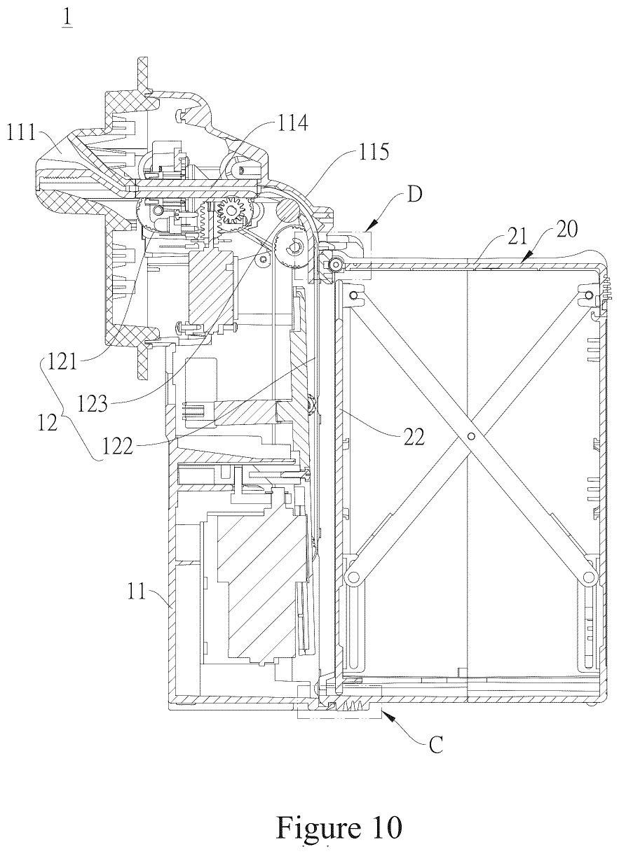

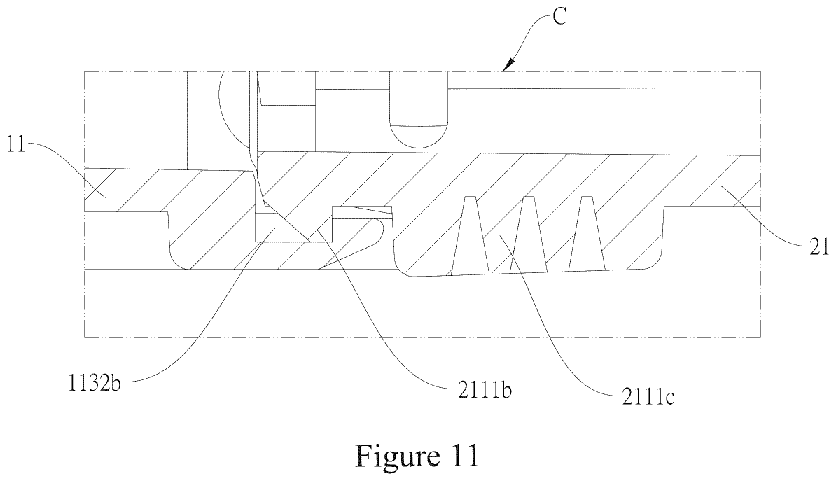

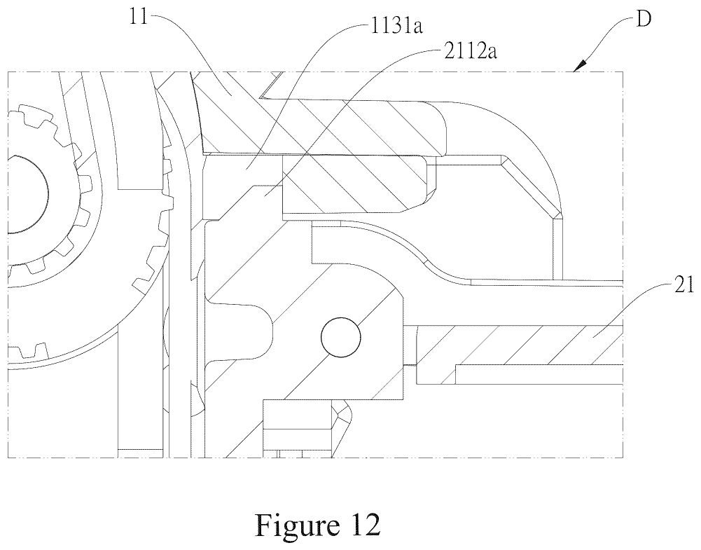

Please refer to FIGS. 9, 10, 11, and 12. The banknote storage module 20 is assembled to the banknote input module 10 from below of the banknote input module 10. The second housing 21 is coupled to the first housing 11. The flange 1133b of the first side wall 1133 abuts against the second side wall 2113 and the second stepped structure 2113a engages with the first stepped structure 1133a, thereby coupling the first combination frame 113 to the second combination frame 211. By aligning the boss 2111c with the second notch 1132c, the latch protrusion 2111a engages with the second latch recess 1132b and the first engagement protrusions 2111b engage with the second engagement recesses 1132a, while the second engagement protrusions 2112a engage with the first engagement recesses 1131a. This causes the first upper wall 1131 and the first lower wall 1132 to correspondingly couple with the second lower wall 2112 and the second upper wall 2111, forming a constraint in three mutually orthogonal directions in three dimensions.

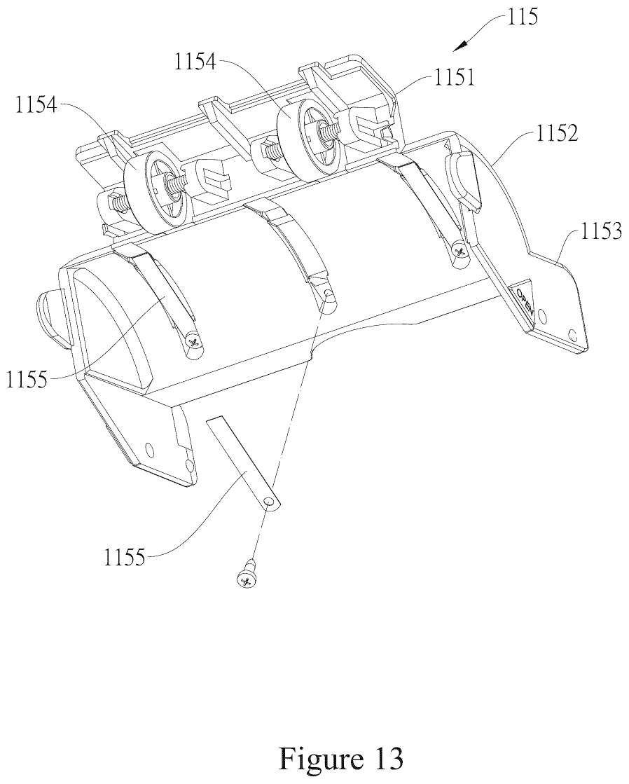

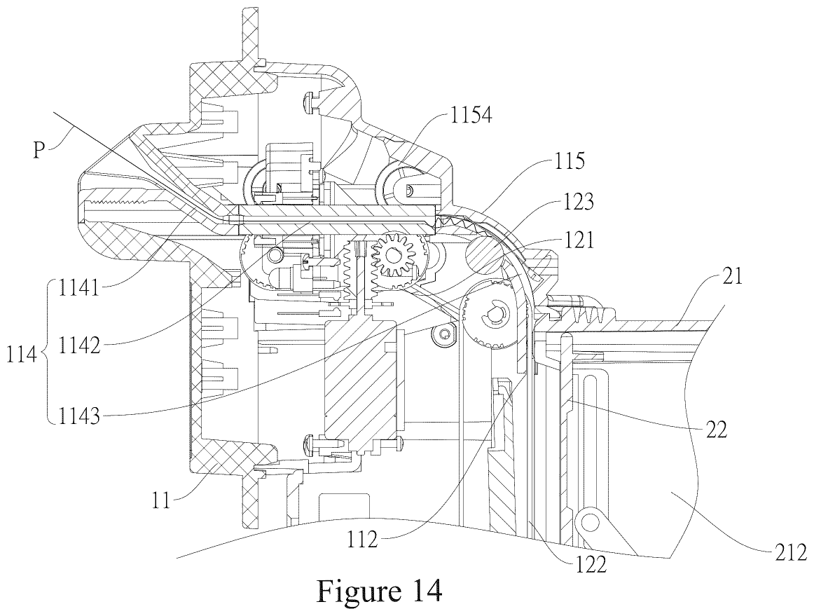

Please refer to FIGS. 13, 14, and 15. The banknote transport path 114 of the first housing 11 connects the banknote inlet 111 and the banknote outlet 112. The banknote transport path 114 includes an inclined section 1141, a horizontal section 1142, and an arcuate section 1143. The horizontal section 1142 is located between the inclined section 1141 and the arcuate section 1143. The inclined section 1141 is connected to the banknote inlet 111 and the arcuate section 1143 is connected to the banknote outlet 112. The height of the banknote inlet 111 is greater than the height of the horizontal section 1142 and the height of the horizontal section 1142 is greater than the height of the banknote outlet 112.

The first housing 11 further includes a back cover 115, which is detachably coupled to the first housing 11 and forms the arcuate section 1143 of the banknote transport path 114 and the banknote outlet 112. The back cover 115 includes a first coupling part 1151, an arcuate part 1152 and a second coupling part 1153. The first coupling part 1151 and the second coupling part 1153 are respectively disposed on opposite sides of the arcuate part 1152. The first coupling part 1151 is coupled to the first housing 11 and the second coupling part 1153 is coupled to the first combination frame 113. The arcuate part 1152 forms the arcuate section 1143 of the banknote transport path 114.

The back cover 115 also includes multiple first transport rollers 1154 and multiple pressing springs 1155. The first transport rollers 1154 are disposed on the first coupling part 1151 and the pressing springs 1155 are disposed on the arcuate part 1152.

The banknote transport mechanism 12 includes a first conveyor belt 121 and a second conveyor belt 122. The first conveyor belt 121 is horizontally disposed on the horizontal section 1142 of the banknote transport path 114 and the second conveyor belt 122 is vertically disposed at the banknote outlet 112 and the first combination frame 113. The first conveyor belt 121 and the second conveyor belt 122 are respectively driven by a motor and a gear set. The first transport rollers 1154 are disposed opposite the first conveyor belt 121. The banknote transport mechanism 12 also includes multiple second transport rollers 123, which are disposed on the arcuate section 1143 of the banknote transport path 114 and are opposite to the arcuate part 1152 of the back cover 115. The pressing springs 1155 abut against the second transport rollers 123.

A banknote P enters the first housing 11 from the banknote inlet 111 and is conveyed through the inclined section 1141 and the horizontal section 1142 of the banknote transport path 114 by the first conveyor belt 121 of the banknote transport mechanism 12 and the first transport rollers 1154 of the back cover 115. The banknote P then enters the arcuate section 1143. In the arcuate section 1143, the banknote P is pressed against the second transport rollers 123 by the pressing springs 1155 and is conveyed by the second conveyor belt 122 through the banknote outlet 112 into the second housing 21 and the banknote storage space 212 through the second combination frame 211. The banknote P is pressed to the second combination frame 211 by the banknote storage pressure plate 22.

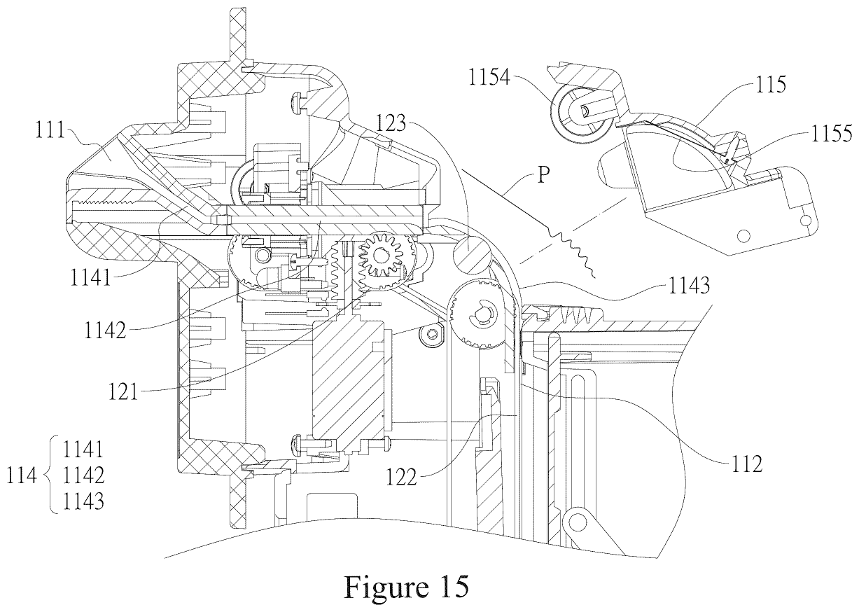

As shown in FIG. 15, when a banknote P passes through the arcuate section 1143, it is squeezed in the arcuate section 1143 due to the banknote P is wrinkled. Therefore, when the banknote P is squeezed and jammed in the arcuate section 1143, the user may remove the back cover 115 and then remove the squeezed banknote P from the arcuate section 1143 to solve the problem of the banknote P jamming the banknote transport path 114 due to the squeeze.

By coupling the first upper wall and the first lower wall of the banknote input module respectively to the second upper wall and the second lower wall of the banknote storage module or the first upper wall and the first lower wall of the banknote input module respectively to the second lower wall and the second upper wall of the banknote storage module, the cash register of the present disclosure allows the banknote storage module to be assembled with the banknote input module from above or below according to the installation location, thereby solving the problem of experiencing difficulties in assemble and disassemble due to obstructions by the building structure or other facilities in the prior art.

However, the above description is only a preferred embodiment of the present disclosure and should not be used to limit the scope of implementation of the present disclosure. Any simple equivalent changes and modifications made according to the scope of the patent application and the content of the specification of the present disclosure are still within the scope covered by the patent of the present disclosure. In addition, any embodiment or patent application scope of the present disclosure does not need to achieve all the disclosed objectives, advantages, or features of the present disclosure. Furthermore, the abstract and titles are only for assisting patent document searches and should not be used to limit the scope of rights of the present disclosure. Also, the terms “first”, “second”, etc., mentioned in the specification or patent application scope of the present disclosure are only used to name the elements or distinguish different embodiments or scopes, and are not used to limit the upper or lower limits of the number of elements.

What is claimed is:

1. A cash register, comprising:
a banknote input module, comprising
a first housing and a banknote transport mechanism, the first housing having a banknote inlet, a banknote outlet and a first combination frame, the first combination frame comprising a first upper wall, a first lower wall and two first side walls, the banknote transport mechanism being disposed in the first housing and located between the banknote inlet and the banknote outlet; and
a banknote storage module, comprising:
a second housing and a banknote storage pressure plate, the second housing having a second combination frame, the second combination frame comprising a second upper wall, a second lower wall and two second side walls, the banknote storage pressure plate being movably disposed in the second housing and abutting against the second combination frame;
wherein by selectively coupling the first upper wall and the first lower wall respectively to the second upper wall and the second lower wall or coupling the first upper wall and the first lower wall respectively to the second lower wall and the second upper wall, the first combination frame being coupled to the second combination frame, thereby combining the banknote input module with the banknote storage module;
wherein a banknote entering the first housing from the banknote inlet and being transported by the banknote transport mechanism and entering the second housing through the banknote outlet, the banknote storage pressure plate pressing the banknote to the second combination frame.

2. The cash register according to claim 1, wherein the first upper wall has two first engagement recesses and a first latch recess disposed between the first engagement recesses, the first lower wall has two second engagement recesses and a second latch recess disposed between the second engagement recesses, the second upper wall has a latch protrusion and two first engagement protrusions disposed on both sides of the latch protrusion, the second lower wall has two second engagement protrusions, the latch protrusion being coupled to the first latch recess or the second latch recess, the first engagement protrusions being coupled to the first engagement recesses or the second engagement recesses, and the second engagement protrusions being coupled to the second engagement recesses or the first engagement recesses.

3. The cash register according to claim 2, wherein the first upper wall has a first notch, the first engagement recesses are disposed on opposite sides of the first notch, the first latch recesses are disposed corresponding to the first notch, the first lower wall has a second notch, the second engagement recesses are disposed on opposite sides of the second notch, the second upper wall has a boss, the first engagement protrusions are disposed on both sides of the boss, the boss is coupled to the first notch or the second notch.

4. The cash register according to claim 1, wherein each of the first side walls has a first stepped structure near one side of the banknote transport mechanism, each of the second side walls has a second stepped structure near one side of a corner of the second housing, and when the banknote input module is combined with the banknote storage module, the first stepped structure is coupled to the second stepped structure.

5. The cash register according to claim 4, wherein each of the first side walls has a flange on a side that is away from the banknote transport mechanism, and when the banknote input module is combined with the banknote storage module, the flange abuts against the second housing.

6. The cash register according to claim 1, wherein the first housing further includes a banknote transport path, the banknote transport path connects the banknote inlet and the banknote outlet; the banknote transport path comprises an inclined section, a horizontal section, and an arcuate section, the horizontal section is located between the inclined section and the arcuate section, the inclined section connects to the banknote inlet, the arcuate section connects to the banknote outlet, a height of the banknote inlet is greater than a height of the horizontal section, and a height of the horizontal section is greater than a height of the banknote outlet.

7. The cash register according to claim 6, wherein the banknote transport mechanism comprises a first conveyor belt and a second conveyor belt, the first conveyor belt is disposed at the horizontal section of the banknote transport path, the second conveyor belt is disposed at the banknote outlet and the first combination frame, the banknote is transported by the first conveyor belt and the second conveyor belt.

8. The cash register according to claim 6, wherein the first housing further includes a back cover, the back cover is detachably coupled to the first housing and forms the arcuate section of the banknote transport path and the banknote outlet, the back cover comprises a first coupling part, an arcuate part and a second coupling part, the first coupling part and the second coupling part are respectively disposed on opposite sides of the arcuate part, the first coupling part is coupled to the first housing, the second coupling part is coupled to the first combination frame, the arcuate part forms the arcuate section of the banknote transport path.

9. The cash register according to claim 8, wherein the back cover further includes at least one first transport roller and at least one pressing spring, the first transport roller is disposed on the first coupling part and is opposite to the first conveyor belt of the banknote transport mechanism, the pressing spring is disposed on the arcuate part.

10. The cash register according to claim 9, wherein the banknote transport mechanism further includes at least one second transport roller, the second transport roller is disposed at the arcuate section of the banknote transport path and is opposite to the arcuate part of the back cover, the pressing spring abuts against the second transport roller.
